(19) United States
(12) Patent Application Publication
(10) Pub. No.: US 2019/0301510 A1
(43) Pub. Date: Oct. 3, 2019

(54) Hanging Device

(71) Applicant: Michael J. Mollo, Budd Lake, NJ (US)

(72) Inventor: Michael J. Mollo, Budd Lake, NJ (US)

(73) Assignee: Michael J. Mollo, Budd Lake, NJ (US)

(21) Appl. No.: 15/944,063

(22) Filed: Apr. 3, 2018

(51) Int. Cl. F16B 15/00; A47G 1/16; F16B 35/04

(52) U.S. Cl. CPC F16B 15/0007; F16B 35/04; A47G 1/16

(57) ABSTRACT

My invention is for an improved hanging device. It is the object of the inventor, to create an improved hanging device. The embodiments of this device are comprised as followed. One end of the device can have a mechanical screw or other means of fastening. In its center will be a stabilizing rim. At the opposing end of the screw with the stabilizing rim between them will be a cylindrical device tapering to a point.

### FIELD OF INVENTION

The invention relates to improved hanging device.

### BACKGROUND OF INVENTION

There have been numerous attempts over the years on hanging devices for example Patent 114-9141 which comprises similar device but has been made in multiple pieces all the way to device patent application US 2018 007-3549 A1. Most of the devices nail a hook to a wall surface. The other half of the device is fastened to an object being hung. My device is affixed to the device being hung only. By affixing my device to the top center line the object will level itself in a pendulum fashion. By pressing the cylindrical pointed device puncturing into the wall the object will be secured onto the wall surface and can easily be removed.

### SUMMARY OF THE INVENTION

The preferred embodiments of my invention is comprised of a single device being attached to an object for hanging purposes such as but not limited to picture frames. To provide easier mounting of said object by pressing the picture or object against the wall. The spike like device on the opposing side of the screw will puncture into the wall. Affixing the picture frame or object securely to the wall.

### DESCRIPTION OF THE PREFERRED EMBODIMENTS

The preferred embodiments of this invention is comprised of a screw like device on one side with a stabilizing rim in the center. At the opposing end of the screw with the stabilizing rim between them will be a cylindrical device tapering to a point.

### DETAIL DESCRIPTION OF INVENTION

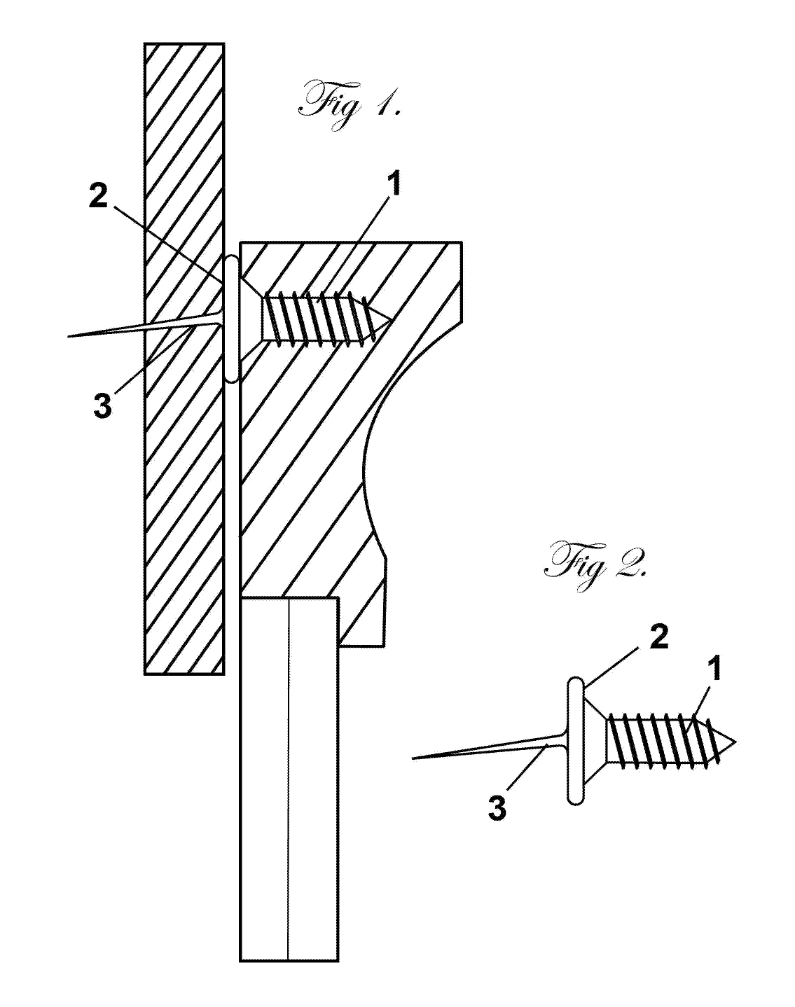

This invention is for an improved hanging device, such as picture frames but limited to. FIG. 1—illustrates the hanging device (1) firmly screwed onto the back of picture frame (2) stabilizing rim pressed firmly to back of frame (3) opposing (1) with (2) between (3) puncturing through the wall firmly hanging picture frame or device on wall. FIG. 2—Illustration of hanging device (1) illustrates screw (2) illustrates stabling device (3) illustrates a device tapering to a point.

1. A single device having a threaded screw.

2. A stabilizing ring.

3. A cylindrical pointed device.
